(19) United States
(12) Patent Application Publication
(10) Pub. No.: US 2005/0266369 A1
(43) Pub. Date: Dec. 1, 2005

(54) Ligature device

(76) Inventors: Gabriele Scommegna, Tavarnuzze Impruneta (FI) (IT); Maurizio Dolfi, Firenze (IT)

Correspondence Address: MCGLEW & TUTTLE, PC, P.O. BOX 9227, SCARBOROUGH STATION, SCARBOROUGH, NY, 10510-9227, US

(21) Appl. No.: 11/116,583

(22) Filed: Apr. 28, 2005

(30) Foreign Application Priority Data
May 26, 2004 (IT) FI2004U000044

(51) Int. Cl. A61C 3/00

(52) U.S. Cl. 433/15

(57) ABSTRACT

Ligature device for othodontic brackets, consisting of an elastic body with a central portion (5) and two lateral rings (6) positioned on two mesodistal sides of said central portion (5), on opposite sides with respect to the latter, said rings being intended to be coupled with the wings (2) of an orthodontic bracket so that said central portion (5) results above the same bracket wings (2), characterized in that said lateral rings (6) form at least a curve (65) corresponding to a mesodistal side of said othodontic bracket at the height of said wings (2), the vertex of said at least one curve (65) being turned toward the orthodontic bracket, that is to say toward said central portion (5) of the ligature device.

The present invention relates to a ligature device for orthodontics.

Orthodontic procedures, in which a plurality of orthodontic brackets are used, have widely been adopted for a long time. Each orthodontic bracket is cemented on the vestibular face of a tooth which belongs to a dental arch under treatment. Along each dental arch, a suitably preformed wire arch passes through the orthodontic brackets. On this purpose, each orthodontic bracket features a slot extending in the mesodistal direction, in which the above wire passes, as well as a retention base. The slot is positioned between two couples of wings emerging from said base which extend in the occlusal gingival direction, between which an elastic ring commonly said “ligature” is applied, so as to prevent the wire escaping out of the slot.

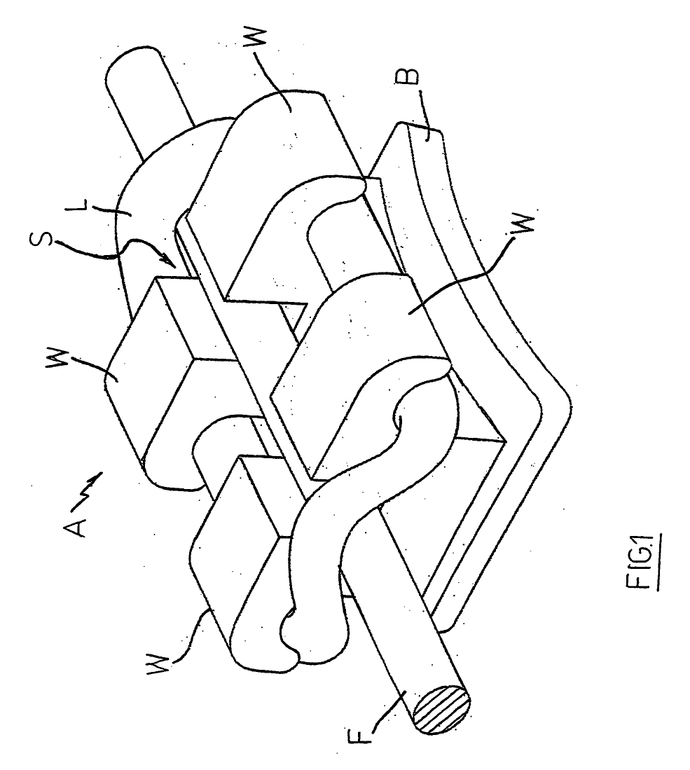

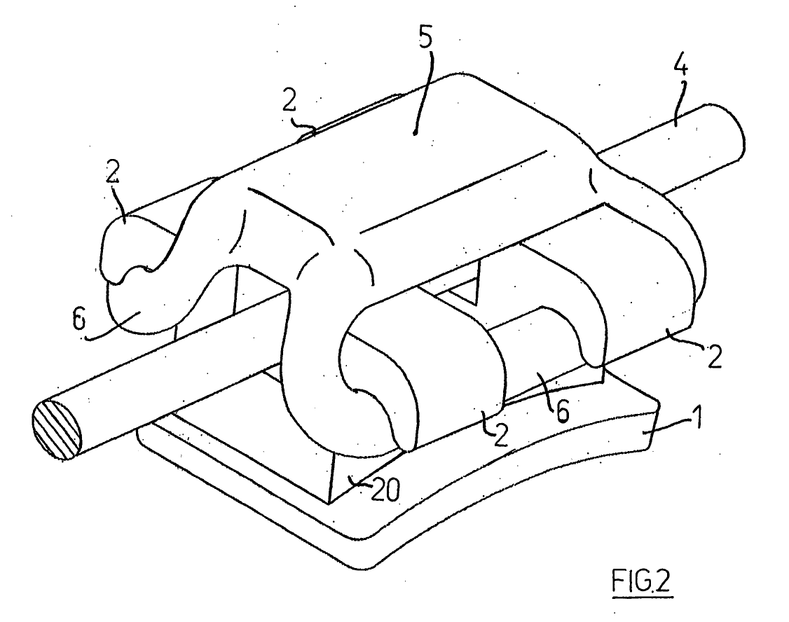

A well-known ligature system is shown in FIG. 1 of the enclosed drawings, in which “A” indicates the orthodontic bracket, “B” indicates the corresponding base, “F” indicates the wire, “S” indicates the slot for wire “F”, “L” indicates the ligature ring and “W” indicates the coupling wings for the ligature ring “L”.

As the preformed wire, once it has been positioned in the slots of the complex of orthodontic brackets applied on the patient's teeth, tends to assume its original form, that is to say a form corresponding to an ideal dental arch, it produces a complex of corrective forces and transmits these forces to the each single tooth by means of the corresponding orthodontic brackets. However, as in the above ligature systems the movements of the preformed wire, which tends to assume its original form, generate remarkable friction due to the contact between the wire itself and the ligature rings mounted on each orthodontic bracket, the elastic energy accumulated in the wire is partially consumed to eliminate friction, so there is a general tendency to oversize the elastic load applied to the wire during the preforming phase. As each single ligature ring tends to lose its elasticity with time and the materials employed to build the preformed wires are such that the elastic energy returned to its original arch conformation during the return phase is constant during the time, the load applied on each tooth progressively increases. This may lead to serious biological damages for the patient and compels the odontologist to examine him frequently.

The present invention aims at eliminating or at least at reducing the above inconveniences.

These results have been achieved, according to the present invention, by a device having the features described in claim 1. Further features of the present invention are the subject of the dependent claims.

Thanks to the present invention it is possible to guarantee an improved possibility of movement of the preformed wire both in the mesodistal direction and by flexion, outside the bracket wings, without modifying the shape or the nature of the preformed wire or of the orthodontic bracket. Therefore, the elastic overload of the wire during its preforming phase can be eliminated or considerably reduced, so as to allow a more correct application of the corrective forces on the interested teeth. Moreover, the ligature device according to the present invention is easy to build, economic, comfortable for the patient, easy to use and reliable, even after a long working time.

All the technicians who work in this field will better understand these advantages and further advantages and features of the present invention thanks to the following description and to the enclosed drawings as a practical explanation of this invention which should not be considered in a limited sense, wherein:

FIG. 1 shows a schematical perspective view of a well-known ligature device mounted on an orthodontic bracket;

FIG. 2 shows a schematic perspective view of a ligature device according to the present invention mounted on the same orthodontic bracket of FIG. 1;

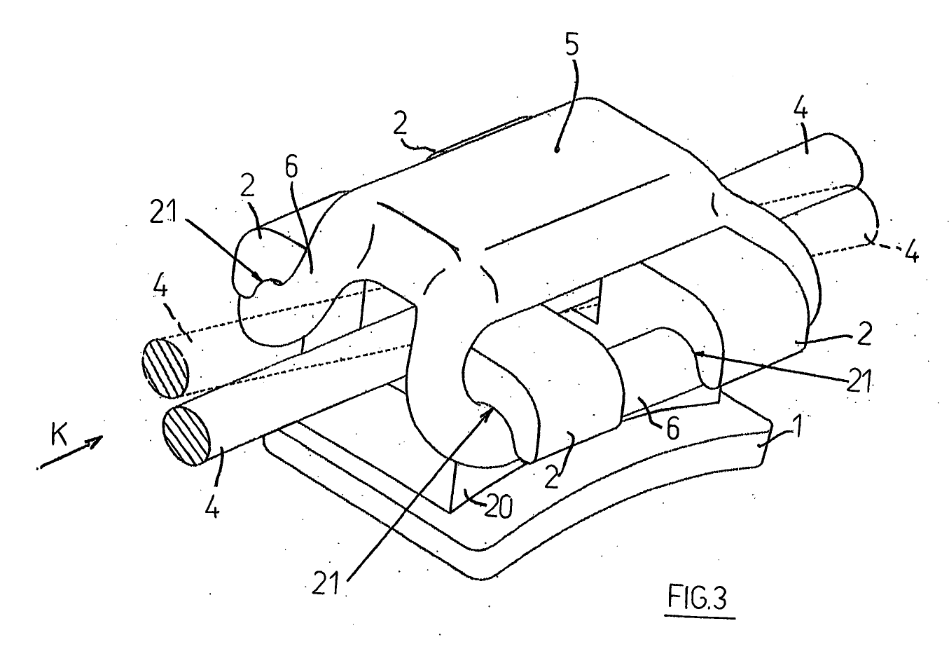

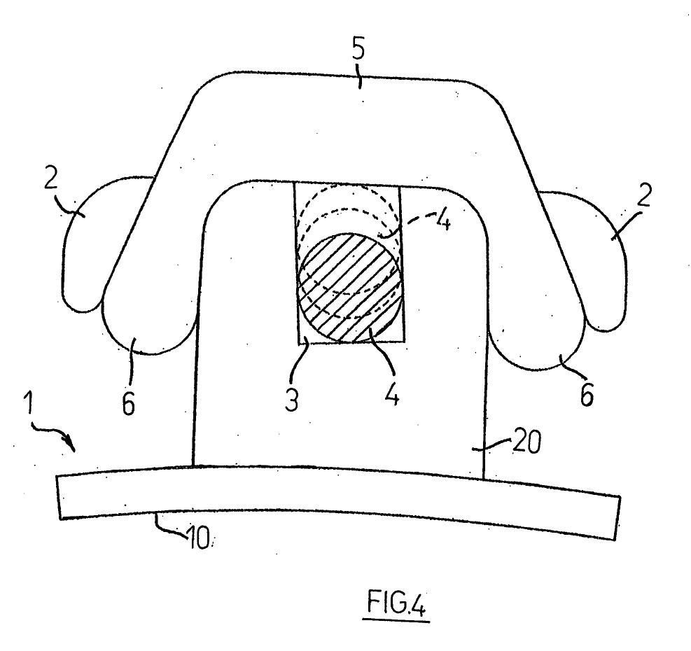

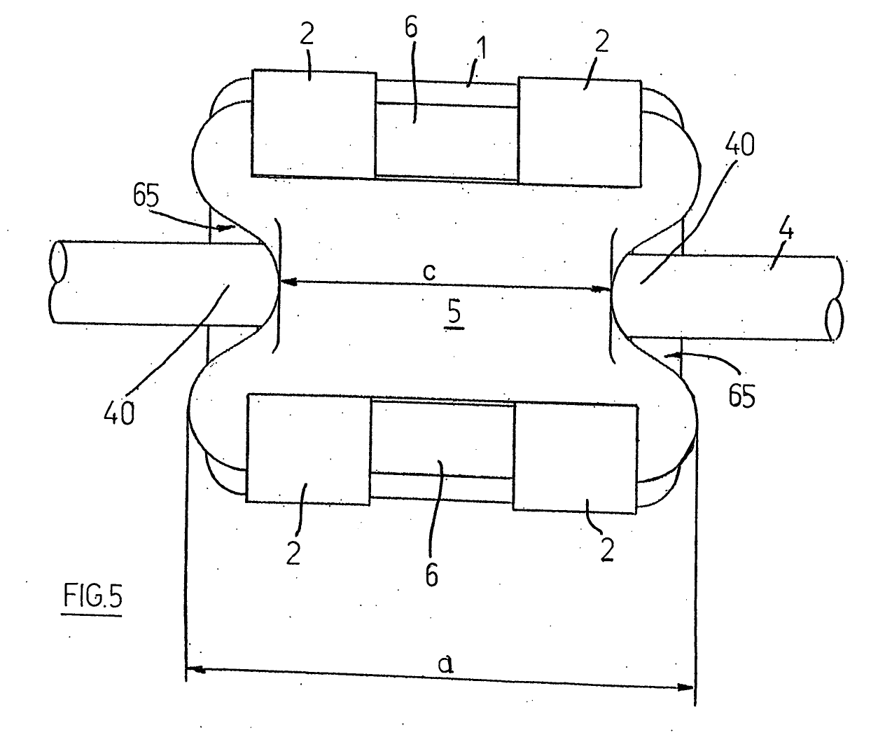

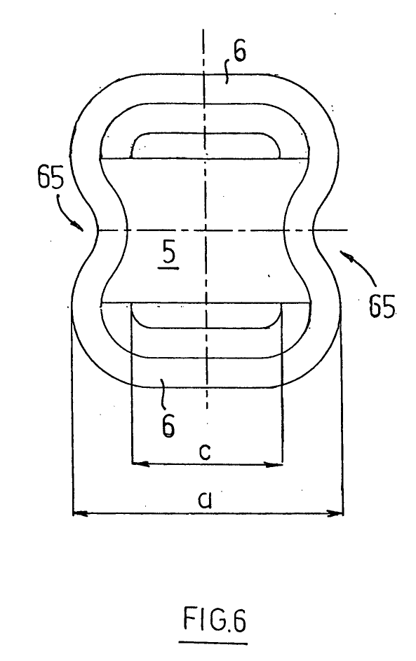

FIG. 3 is a view identical to that of FIG. 2 which schematically shows a possible movement of the wire inside and outside the corresponding slot;

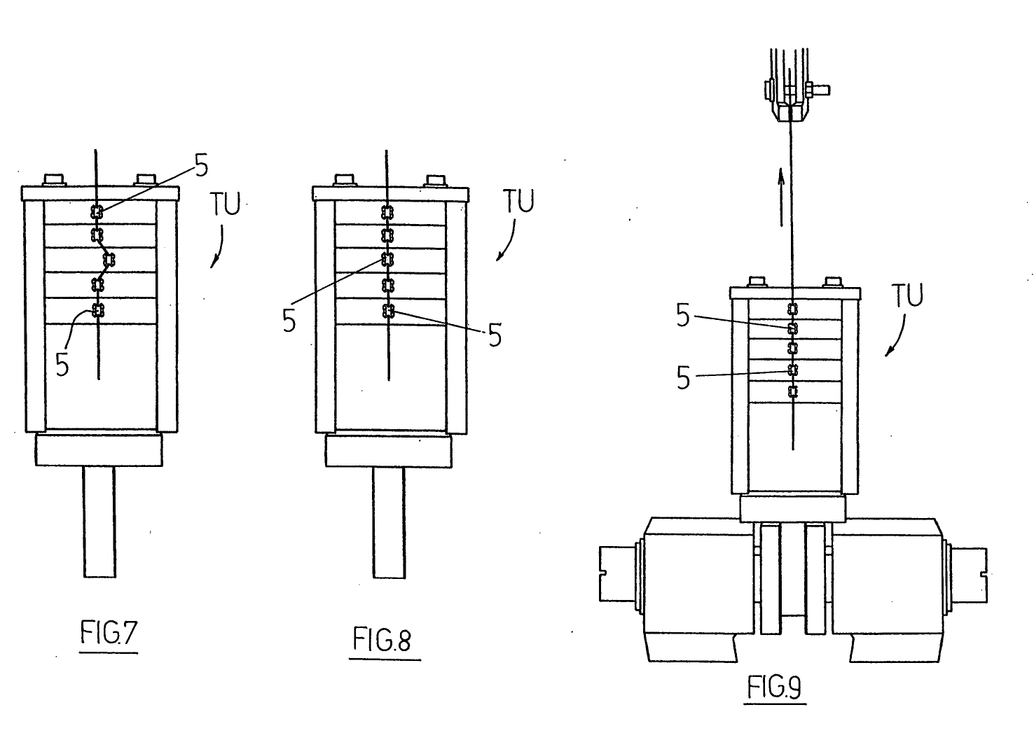

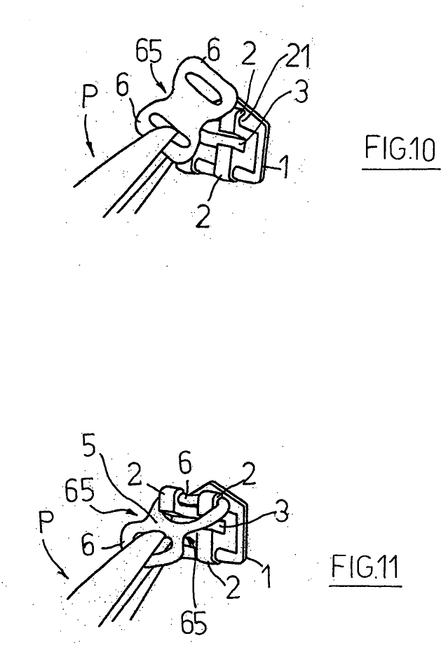

FIG. 4 shows a schematical plant view from “K” of the device shown in FIG. 3;

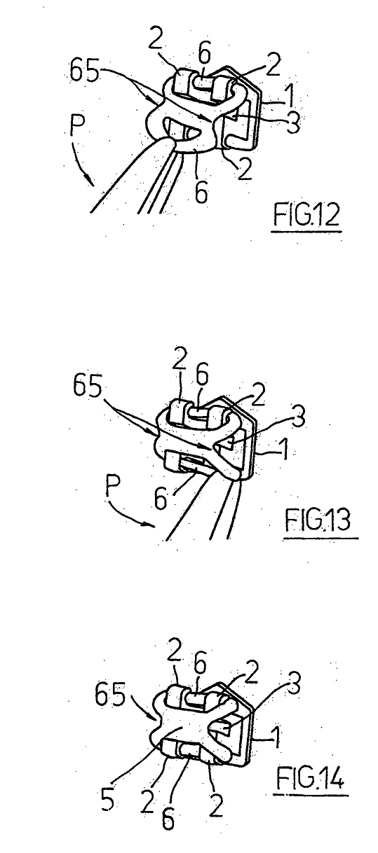

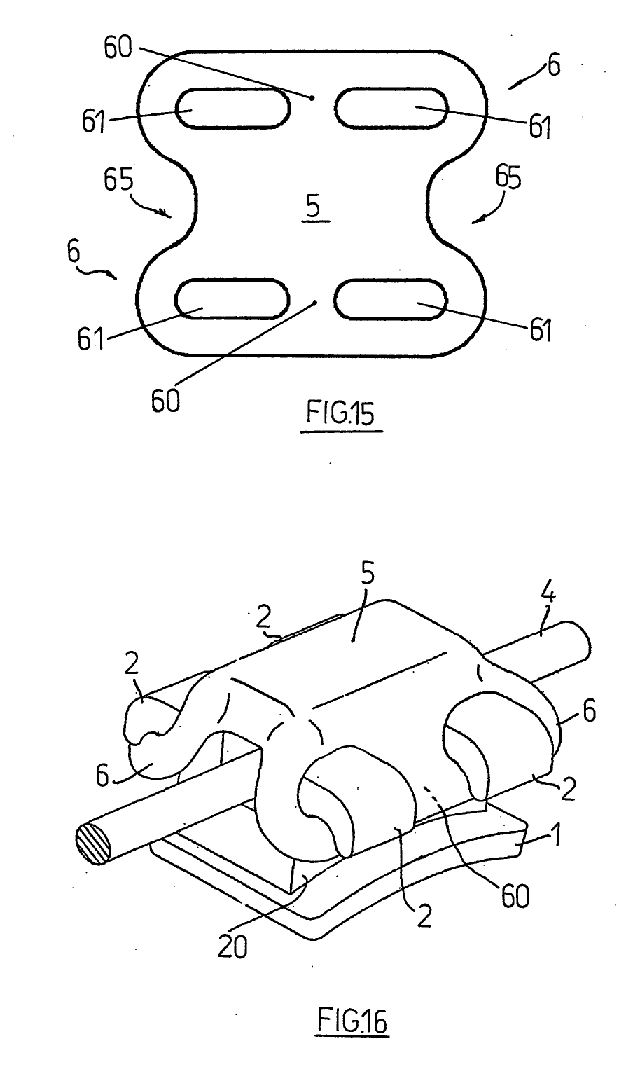

FIG. 5 shows a schematical plant view of the device shown in FIG. 2.

According to FIGS. 2-5 of the enclosed drawings, a ligature device for orthodontic brackets according to the present invention is designed to be mounted on any orthodontic bracket available on the market, that is to say an orthodontic bracket comprising a base (1) with a surface (10) to be cemented on the vestibular face of a tooth and more wings defined by a body (20) which emerges from said base (1) on the side opposite to that of said surface (10). Said wings (2) extend in the occlusal gingival direction, while a slot (3) extends between them in the mesodistal direction, so as to allow the passage of a corresponding arch portion of a preformed wire (4). Moreover, each of said wings (2) features a a lower surface, that is to say a surface (21) which is turned toward the base (1) of the orthodontic bracket so that the ligature device can be coupled with it, as described in detail below.

Said wire (4) can be of any kind available on the market.

A ligature device according to the present invention consists of a body in elastic, biocompatible material, comprising a central potion (5) having a basically rectangular plant and two side rings (6), that is to say two rings which are on opposite sides with respect to said central portion (5). Said rings (6) are basically developed along the longer sides of said central portion (5), that is to say developed according to the mesodistal direction.

According to the example shown in FIGS. 2-5 of the enclosed drawings, each of the longer sides of said central portion (5) is also a part of a corresponding ring (6). Said body (5, 6) consists of a single, i.e. unitary, element and the length (a) of each lateral ring (6) exceeds the length (c) of the central body (5). In this way, as the central portion (5) of the ligature device is mounted above the wings (2) of a corresponding orthodontic aid and the lateral rings (6) are coupled with the lower surfaces (21) of the same wings, and the rings are longer than the central portion, the wire (4) cannot escape out of the slot but it is free to move in correspondence of the two shorter sides of said central portion (5). In other terms, as rings (6) are longer than the central portion (5) of the ligature device, the latter is provided with two curves (65), well visible in the plant view of FIG. 5, which leave two corresponding portions (40) of the wire (4) uncovered. Therefore, said wire portions (40) are free to move (compatibly with the upper link consisting of the central portion 5 of the device and with the lower link consisting of the base 1 of the orthodontic bracket) as FIGS. 3 and 4 schematically show. The vertex of each of said curves (65) is turned toward the orthodontic bracket, that is to say toward the above mentioned central portion (5). These features of the ligature device offer the above-mentioned advantages.

The example shown in FIGS. 2-5 of the enclosed drawings refers to a symmetric embodiment of the ligature device, with said curves (65) which are symmetrically positioned in correspondence of the two short sides of said central portion (5).

However, the above device can obviously be asymmetric, i.e. it can feature only one of said curves (65) in correspondence of one short side of the central portion (5) of the ligature device. In this case, the above mentioned freedom of movement of wire (4) is guaranteed on one side of the orthodontic bracket only instead of on both sides of the latter.

“Long side” or “longer side” obviously means a side which extends in the mesodistal direction and “short side” or “shorter side” means a side which extends in the occlusal-gingival direction.

The above device, for example, can be made in thermoplastic polyuretane, in any colour.

The hardness of the material used for the above ligature device preferably ranges from Shore A 80 to Shore A 90.

Practically, the construction details may vary in any equivalent way as far as the shape, dimensions, elements disposition, nature of the used materials are concerned, without nevertheless departing from the scope of the adopted solution idea and, thereby, remaining within the limits of the protection granted to the present patent.

1. Ligature device for othodontic brackets, consisting of an elastic body with a central portion (5) and two lateral rings (6) positioned on two mesodistal sides of said central portion (5), on opposite sides with respect to the latter, said rings being intended to be coupled with the wings (2) of an orthodontic bracket so that said central portion (5) results above the same bracket wings (2), characterized in that said lateral rings (6) form at least a curve (65) corresponding to a mesodistal side of said othodontic bracket at the height of said wings (2), the vertex of said at least one curve (65) being turned toward the orthodontic bracket, that is to say toward said central portion (5) of the ligature device.

2. Device according to claim 1 characterized in that the length (a) of each of said rings (6) exceeds the length (c) of said central portion (5).

3. Device according to claim 1 characterized in that it consists of one element.

4. Device according to claim 1 characterized in that it is made of thermoplastic polyutherane.

5. Device according to claim 1 characterized in that its hardness ranges from Shore A80 to Shore A90.

6. Device according to claim 1 characterized in that it is symmetric.

7. Device according to claim 1 characterized in that it is asymmetric.
